(19) United States
(12) Patent Application Publication
(10) Pub. No.: US 2026/0219730 A1
(43) Pub. Date: Jul. 30, 2026

(54) BRIGHTNESS CONTROL OF INFOTAINMENT SYSTEM IN VEHICLES USING EYE-GAZE ESTIMATION

(71) Applicant: MERCEDES-BENZ GROUP AG, Stuttgart (DE)

(72) Inventors: Sujay BABRUWAD, Bengaluru (IN); Sourav LAKHOTIA, Bangalore (IN); Saurav GUPTA, Bangalore (IN); Shuaib AHMED, Bangalore (IN)

(21) Appl. No.: 19/146,577

(22) PCT Filed: Dec. 20, 2023
(86) PCT No.: PCT/EP2023/086917

§ 371 Date: Jul. 9, 2025

(30) Foreign Application Priority Data
Jan. 10, 2023 (GB) 2300343.7

(51) Int. Cl. G06F 3/01; B60Q 9/00; G06T 7/73; G06V 10/26; G06V 20/59; G06V 40/16

(52) U.S. Cl. CPC G06F 3/013; B60Q 9/00; G06T 7/74; G06V 10/26; G06V 40/166; G06T 2207/20081; G06T 2207/20084; G06T 2207/30201; G06V 20/59

(57) ABSTRACT

An infotainment brightness control system for a vehicle includes a processing device with a pre-trained eye gaze detection module and a learning module. The processing device determines, based on images of eye region(s) of a user, a yaw and a pitch indicative of a gaze direction of the user for a real-time frame, and previous time frames. The processing device estimates a subsequent eye gaze direction of the user based on the gaze directions determined for the real-time frame and the previous time frames. The processing device adjusts brightness of a display of the infotainment system at a predefined level based on an overlap between display of the infotainment system and the estimated subsequent gaze direction.

### TECHNICAL FIELD

Exemplary embodiments of the present invention relate to the field of infotainment units for vehicles, and in particular to a system and a method for controlling brightness of an infotainment screen in a vehicle using eye-gaze estimation.

### BACKGROUND

Vehicles are provided with an infotainment unit that combines and provides entertainment and information to passengers of the vehicle. Typically, the infotainment screen or display automatically turns ON once the ignition key of the vehicle is turned ON and the infotainment screen remains ON during the complete travel time until the ignition key is again turned OFF. The infotainment system generally draws electrical power from the battery of the vehicle, which in turn draws power from a power pack of the vehicle or electrical power from external power sources during charging of the battery.

As the worldwide consumption of electrical power is growing with negative consequences for the environment and society, the world is focusing on having sustainable resources and energy conservation. Smartly controlling brightness and turn ON time of the infotainment devices would also help in reducing the energy consumption to some extent. For example, while driving, the driver of the vehicle may look at the screen for directions, and for the rest of the time may look elsewhere, however, the infotainment screen remains ON at the same brightness level even if the driver looking elsewhere. It would, therefore, be advantageous from the point of view of energy conservation and sustainability, if a simple, automated, and efficient solution to enable the infotainment screen only when the driver is looking at the screen, could be provided.

In addition, during night driving, light from the infotainment screen causes eye strain and distracts the driver's attention. Therefore, it would be further advantageous from the point of view of safety and comfort of the driver if a simple, automated, and efficient solution to control the brightness of the infotainment screen based on the driver's eye gaze could be provided. However, accurately identifying the gaze direction in which the driver of the vehicle is looking is a challenge. The conventional systems predict current gaze vector, which at per-frame level may not be stable as the gaze vectors are usually prone to a lot of flicker due to fine grained movement of the eyes.

Patent document number KR 101469978A discloses a brightness adjusting apparatus for a vehicle display device. The apparatus includes a visual line detection unit for detecting the driver's gaze detection based on the face direction and the eye direction of the driver, and a pupil diameter detection unit for detecting the pupil diameter detection value of the driver. The brightness of the display device is changed based on diameter of the pupil of the eye of the driver.

The methodology of the above-cited reference, being based on the face direction and eye direction, does not provide a very accurate estimate of the current gaze direction of the user.

There is, therefore, a need in the art to overcome the above-mentioned drawbacks, limitations, and shortcomings, by accurately identifying the direction in which the occupant is looking and may be looking while driving a vehicle to help control the brightness of the infotainment screen of the vehicle in order to provide a comfortable driving experience and to conserve energy.

### SUMMARY OF THE INVENTION

Exemplary embodiments of the present invention relate to controlling the brightness of an infotainment system in a vehicle based on the eye-gaze direction of the driver.

Exemplary embodiments of the present invention relate to a system and a method for controlling the brightness of an infotainment system in a vehicle using eye-gaze estimation.

Exemplary embodiments of the present invention relate to accurately identifying the direction in which the driver is looking and will be looking while driving a vehicle to help control the brightness of the infotainment screen of the vehicle.

Exemplary embodiments of the present invention relate to a system and a method for controlling the brightness of an infotainment system, which helps reduce eye strain and distraction to drivers during night time.

Exemplary embodiments of the present invention relate to a system and a method that provides hands-free brightness control of an infotainment system in vehicles.

Exemplary embodiments of the present invention relate to efficiently controlling the brightness of the infotainment system screen in vehicles to save energy and provide a comfortable driving experience.

Aspects of the present invention relate to the field of infotainment units for vehicles. In particular, the present disclosure provides a system and a method for controlling the brightness of an infotainment system in a vehicle using eye-gaze estimation.

An aspect of the present invention pertains to an infotainment brightness control system for a vehicle. The system comprises a processing device configured with a pre-trained eye gaze detection module and a learning module. The processing device comprises a processor coupled with a memory, wherein the memory stores one or more instructions executable by the processor to: determine, using the pre-trained eye gaze detection module, based on one or more images of one or more eye region of a user, a yaw and a pitch indicative of a gaze direction of the user for a real-time frame, and one or more previous time frames; estimate, using the learning module, a subsequent eye gaze direction of the user based on the gaze directions determined for the real-time frame, and the one or more previous time frames; and transmit a set of control signals to the infotainment system to adjust brightness of a display of the infotainment system at a predefined level based on an overlap between one or more regions of interest (ROI) associated with an interior of the vehicle, and the estimated subsequent gaze direction.

The processing device may be configured to project the estimated subsequent gaze direction in a 3D car coordinate system, and match the estimated subsequent gaze direction with the one or more ROI in the interior of the vehicle.

The one or more ROI may be associated with the display of the vehicle or the infotainment system.

The processing device may be configured to derive a confidence region indicative of an ellipse in the interior of the vehicle, wherein the yaw and pitch of the estimated subsequent gaze direction correspond to center points of the ellipse, and variance of the yaw and pitch of the corresponding gaze directions being determined for the real-time frame, and the one or more previous time frames corresponds to radii of the ellipse; and calculate the overlap between the ellipse and the one or more ROI, and correspondingly adjust the brightness of the display, wherein the processing device triggers the one or more ROI of the infotainment system when the derived confidence region lies inside the one or more ROI.

The pre-trained eye gaze detection module may comprise: a first branch comprising a first neural network architecture to regress the corresponding images of the eye to gaze maps, and a second neural network architecture to regress the gaze maps to the gaze direction represented by the yaw and pitch; and a second branch fed by the gaze maps and configured as a classification network architecture to reduce entropy loss for enabling the model to determine real gaze maps based on training with synthetic data, wherein the eye gaze detection module is pre-trained with synthetic and/or real-time data including cropped images of eye regions.

The processing device may be configured to detect eye occlusion on at least one of the eye regions from the captured one or more images, and correspondingly selects and detects the corresponding gaze direction from a non-occluded eye image.

The processing device may be configured to keep the brightness level of the display at the predefined level for a predefined time after the estimated subsequent gaze direction exits the ROI.

Another aspect of the present disclosure pertains to a method for controlling brightness of an infotainment system of a vehicle. The method comprises the steps of: determining, by a processing device configured with a pre-trained eye gaze detection module, a yaw and a pitch indicative of a gaze direction of a user for a real-time frame, and one or more previous time frames based on one or more images of one or more eye region of the user; estimating, using a learning module of the processing device, a subsequent eye gaze direction of the user based on the corresponding gaze directions determined for the real-time frame, and the one or more previous time frames; and adjusting brightness of a display of the infotainment system at a predefined level based on an overlap between one or more region of interest (ROI) associated with an interior of the vehicle, and the estimated subsequent gaze direction.

The method may further include the steps of: capturing, by an image acquisition unit comprising a camera, the one or more images of a face of the user, cropping, by the processing device, the one or more eye region from the captured one or more images of the face; determining, by the processing device, based on the cropped images of the eye region, the yaw and pitch indicative of the gaze direction of the user.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrates an exemplary block diagram of the proposed system for controlling the brightness of the display of an infotainment system in a vehicle, in accordance with embodiments of the present invention.

FIG. 2 illustrates an exemplary block diagram representing functional units of a processing device associated with the proposed system, in accordance with embodiments of the present invention.

FIG. 3 illustrates an exemplary view of the interior of the vehicle comprising the camera, and the infotainment system to elaborate upon the working of the invention, in accordance with embodiments of the present disclosure.

FIG. 4A illustrates a flow diagram representing steps of the proposed method for controlling the brightness of the display of an infotainment system of a vehicle, in accordance with an embodiment of the present disclosure.

FIG. 4B illustrates an exemplary flow chart depicting the operation of the proposed system and method for controlling the brightness of the display of an infotainment system of a vehicle, in accordance with embodiments of the present disclosure

FIG. 5A illustrates an exemplary architecture of the gaze detection module of the proposed system, in accordance with embodiments of the present disclosure.

FIG. 5B illustrates an exemplary architecture of the gaze detection module of the proposed system using an LSTM model, in accordance with an embodiment of the present disclosure.

FIG. 6 illustrates an exemplary representation of the final gaze prediction as a 2-D ellipse being predicted by the proposed system, in accordance with embodiments of the present disclosure.

FIG. 7 illustrates an exemplary view depicting the intersection of the 2D-ellipse corresponding to the predicted gaze direction with the ROI of the infotainment system to elaborate upon the working of the invention, in accordance with embodiments of the present disclosure

### DETAILED DESCRIPTION

The following is a detailed description of embodiments of the disclosure depicted in the accompanying drawings. The embodiments are in such details as to clearly communicate the disclosure. However, the amount of detail offered is not intended to limit the anticipated variations of embodiments; on the contrary, the intention is to cover all modifications, equivalents, and alternatives falling within the spirit and scope of the present disclosures as defined by the appended claims.

Embodiments explained herein relate to a system and method for controlling the brightness of an infotainment system in a vehicle using eye-gaze estimation.

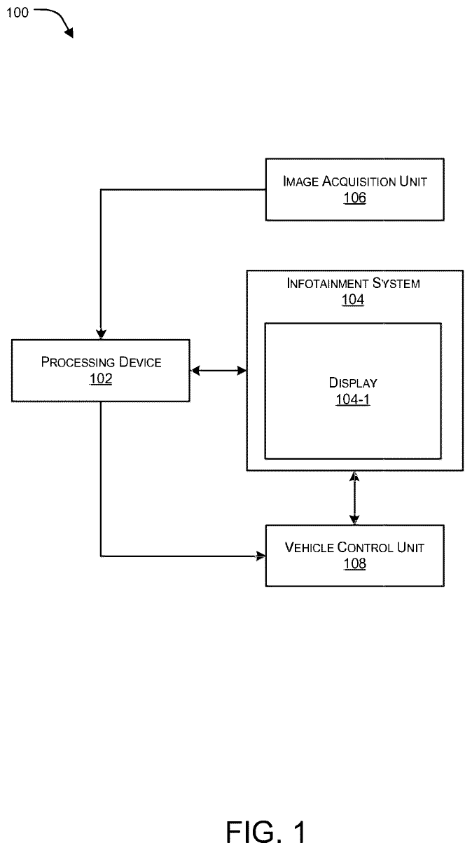

Referring to FIG. 1, where the disclosed system 100 for controlling the brightness of a display of an infotainment system in a vehicle (also referred to as system 100, herein) is disclosed. The system 100 accurately identifies the direction in which an occupant/user/driver of the vehicle is currently looking and will be looking in a subsequent time frame while driving the vehicle to help control the brightness of the infotainment screen of the vehicle in order to provide a comfortable driving experience and conserve energy.

In an embodiment, the system 100 can include a processing device 102 in communication with an infotainment system 104 (also referred to as a head unit, herein) of a vehicle. In another embodiment, the processing device 102 can be a server that can remain in communication with the infotainment systems 104 associated with one or more vehicles. The system 100 can further include an image acquisition unit 106 comprising one or more image sensors or cameras (collectively referred to as cameras or image sensors, herein) installed within the vehicle to capture one or more images or videos of users, including a driver, passenger and/or occupant, sitting/traveling in the vehicle. The image acquisition unit 106 can also capture images or videos of a road or outside view of the vehicle. The image acquisition unit 106 can be in communication with the processing device 102 and/or a vehicle control unit (VCU) 108 of the vehicle.

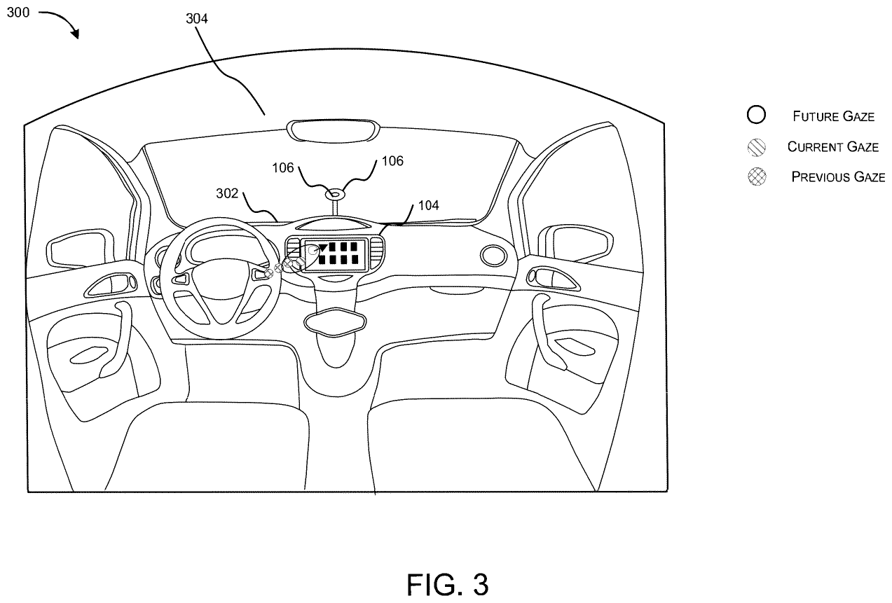

Referring to FIG. 3, where an exemplary view of interior of a vehicle 300 is shown, the infotainment system 104 is typically installed on a dashboard 302 in the interior of the vehicle 300. Further, the image acquisition unit 106 comprising camera(s) or/and image sensor(s) 106 can also be installed in the vehicle interior to capture or monitor images or video of the face of the user/driver in a real-time. The camera 106 can be facing toward front seats of the vehicle 300 where the user/driver may be sitting. The camera or image sensors 106 may be positioned on the dashboard 302 or ceiling 304 of the vehicle 300 for providing full coverage of the interiors of the vehicle 300 and capturing the images of the face of the user/driver. The camera 106 may be an Infra-Red (IR) camera such as a near-infrared camera, a mid-wave infrared camera, and long-wave infrared camera, and so forth.

In one embodiment, the infotainment system 104 can include an input unit such as a keyboard and/or buttons, an output unit comprising a display interface 104-1 (also referred to as display, herein) and/or speakers for audio/visual output, and a communication unit for enabling communication of the infotainment system 104 with the processing device 102 and the VCU 108 of the vehicle. In another embodiment, the infotainment system 104 can be connected to a power source of the vehicle 300 via a wired media or can include an inbuilt power source.

In an embodiment, the processing device 102 can be in communication with or operatively coupled to the image acquisition unit 106, the infotainment system 104, and the VCU 108 of the vehicle, through a network. Further, the network can be a wireless network, a wired network or a combination thereof that can be implemented as one of the different types of networks, such as Intranet, Local Area Network (LAN), Wide Area Network (WAN), Internet, and the like. Further, the network can either be a dedicated network or a shared network. The shared network can represent an association of different types of networks that can use a variety of protocols, for example, Hypertext Transfer Protocol (HTTP), Transmission Control Protocol/Internet Protocol (TCP/IP), Wireless Application Protocol (WAP), and the like.

In an embodiment, the processing device 102 can be implemented using any or a combination of hardware components and software components such as a cloud, a server, a computing system, a computing device, a network device, and the like. Further, the processing device 102 can interact with the image acquisition unit 106, the infotainment system 104, and the VCU 108 through the wired or wireless network.

The image acquisition unit 106 can be configured to capture the images/videos of the face of the user/driver. The processing device 102 can be configured with a pre-trained eye gaze detection module that can enable the processing device 102 to crop one or more eye regions from the captured images of the face of the user/driver and correspondingly determine a yaw and a pitch indicative of a gaze direction of the user/driver for a real-time frame as well as for one or more previous time frames. The processing device 102 can be further configured with a learning module such as an LSTM model, but not limited to the like, that can enable the processing device 102 to estimate a subsequent eye gaze direction of the user/driver based on the gaze directions being determined for the real-time frame, and the one or more previous time frames. Accordingly, the processing device 102 can transmit a set of control signals to the infotainment system 104 or VCU 108 to adjust the brightness of the display of the infotainment system 104 at a predefined level based on an overlap between the display area of the infotainment system and the estimated subsequent gaze direction of the user/driver. The system 100 accurately identifies the direction in which the driver is currently looking at and will be looking at in subsequent time frames while driving the vehicle, which helps control the brightness of the infotainment screen/display 104-1 of the vehicle efficiently and comfortably.

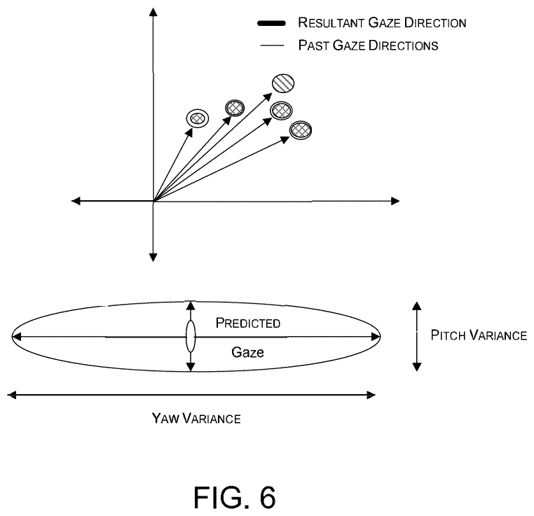

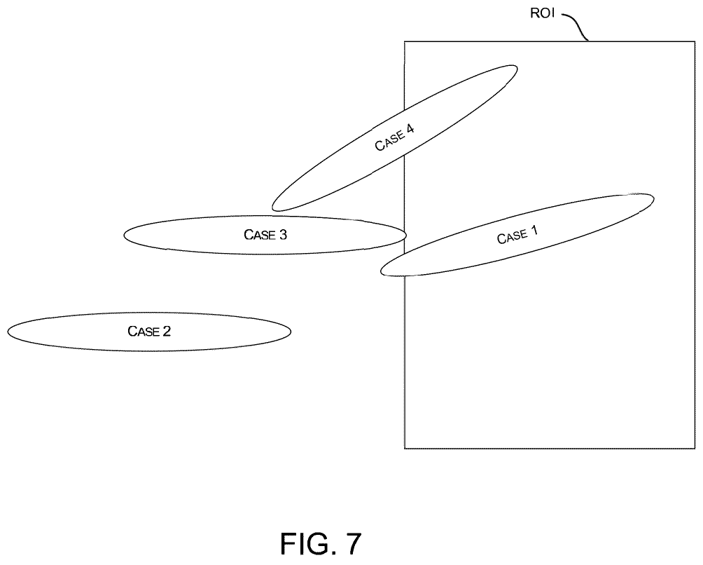

In an embodiment, the processing device 102 can be configured to project the estimated subsequent gaze direction in a 3D coordinate system of the vehicle as shown in FIG. 3 and FIG. 6, and match the estimated subsequent gaze direction with one or more regions of interest (ROI) of the display 104-1 in the interior of the vehicle as shown in FIG. 7. The processing device 102 can be configured to derive a confidence region indicative of an ellipse in the interior of the vehicle, where the yaw and pitch of the estimated subsequent gaze direction can correspond to center points of the ellipse, and variance of the yaw and pitch of the corresponding gaze directions being determined for the real-time frame, and the one or more previous time frames can correspond to radii of the ellipse as shown in the FIG. 6.

Furthermore, the processing device 102 can calculate the overlap between the ellipse and the ROI (display 104-1 of the infotainment system 104) as shown in FIG. 7 and can correspondingly adjust the brightness of the display 104-1. The processing device 102 can trigger the ROI of the display 104-1 of the infotainment system 104 when the derived confidence region (ellipse) lies inside the ROI of the display 104-1 of the infotainment system 104.

In an embodiment, the pre-trained eye gaze detection module can include a first branch comprising a first neural network architecture to regress the corresponding images of the eye to gaze maps. Further, the pre-trained eye gaze detection module can include a second neural network architecture to regress the gaze maps to the gaze direction represented by the yaw and pitch. The pre-trained eye gaze detection module can include a second branch fed by the gaze maps and configured as a classification network architecture to reduce entropy loss for enabling the model to determine real gaze maps based on training with synthetic data.

In an exemplary embodiment, the eye gaze detection module can be pre-trained with synthetic and/or real-time data. The pre-trained eye gaze detection module can enable the processing device to detect eye occlusion on at least one of the eye regions from the captured images. The processing device 102 can correspondingly select and detect the corresponding gaze direction from a non-occluded eye image. This allows the system 100 to identify the direction in which the user/driver wearing eyeglasses or sunglasses is looking and will be looking while driving the vehicle to help control the brightness of the infotainment screen 104-1 of the vehicle. In an implementation, the processing device 102 can be configured to keep the brightness level of the display 104-1 at the predefined level for a predefined time after the estimated subsequent gaze direction exits the ROI/display area of the infotainment system 104.

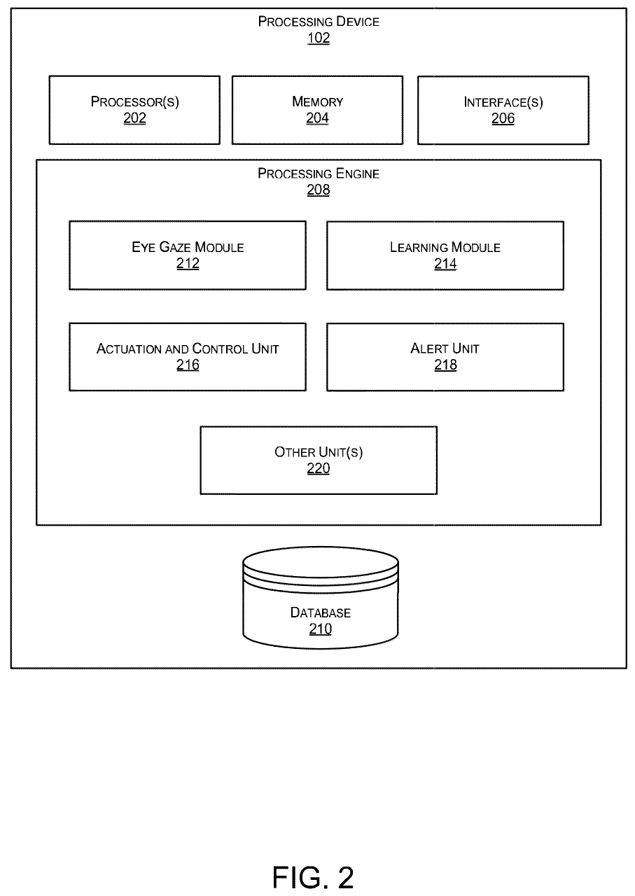

Referring to FIG. 2, block diagram depicts exemplary functional units of the processing device 102 that can include one or more processor(s) 202, memory 204, interface(s) 206, processing engine(s) 208, and database 210. The one or more processor(s) 202 can be implemented as one or more microprocessors, microcomputers, microcontrollers, digital signal processors, central processing units, logic circuitries, and/or any devices that manipulate data based on operational instructions. Among other capabilities, the one or more processor(s) 202 may be configured to fetch and execute computer-readable instructions stored in a memory of a server. The memory 204 can store one or more computer-readable instructions or routines, which may be fetched and executed to create or share the data units over a network service. The memory 204 can include any non-transitory storage device including, for example, volatile memory such as RAM, or non-volatile memory such as EPROM, flash memory, and the like.

In an embodiment, the processing device 102 can also include an interface(s) 206. The interface(s) 206 may include a variety of interfaces, for example, interfaces for data input and output devices, referred to as I/O devices, storage devices, and the like. The interface(s) 206 may facilitate communication of the processing device 102 with various devices coupled to a server, such as the infotainment system, the image acquisition unit, the VCU, and power source of the vehicle. The interface(s) 206 may also provide a communication pathway for one or more components of the processing device 102. Examples of such components include, but are not limited to, processing engine(s) 208 and database 210.

In an embodiment, the processing engine(s) 208 can be implemented as a combination of hardware and programming (for example, programmable instructions) to implement one or more functionalities of the processing engine(s) 208. In examples described herein, such combinations of hardware and programming may be implemented in several different ways. For example, the programming for the processing engine(s) 208 may be processor executable instructions stored on a non-transitory machine-readable storage medium and the hardware for the processing engine(s) 208 may include a processing resource (for example, one or more processors), to execute such instructions. In the present examples, the machine-readable storage medium may store instructions that, when executed by the processing resource, implement the processing engine(s) 208. In such examples, the processing device 102 can include the machine-readable storage medium storing the instructions and the processing resource to execute the instructions, or the machine-readable storage medium may be separate but accessible to the processing device 102 and the processing resource. In other examples, the processing engine(s) 208 may be implemented by electronic circuitry. The database 210 can include data that is either stored or generated as a result of functionalities implemented by any of the components of the processing engine(s) 208.

In an embodiment, the processing engine(s) 208 can include an eye gaze detection module 212, a learning module 214, an actuation and control unit 216, an alert unit 218, and other unit(s) 220. The other unit(s) 220 can implement functionalities that supplement applications or functions performed by the processing device 102 or the processing engine(s) 208.

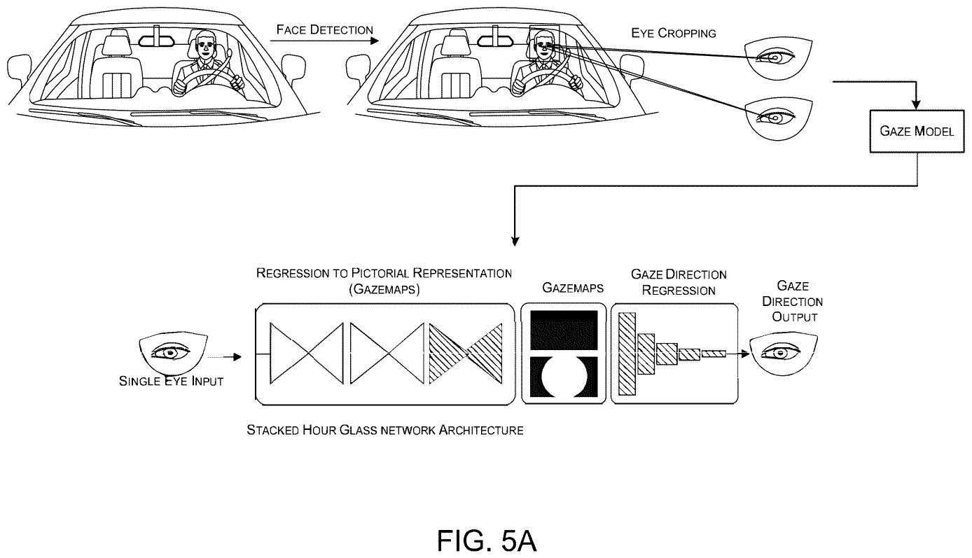

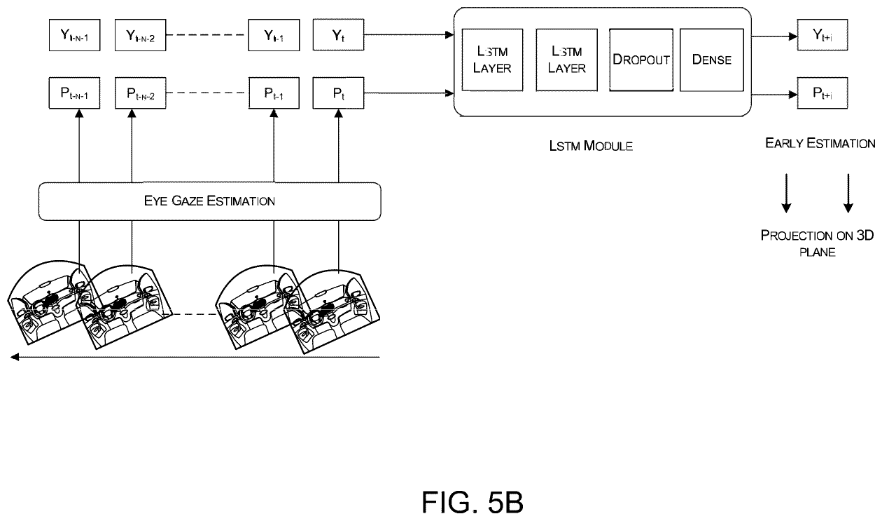

According to an embodiment, the eye gaze detection module 212 can cause the processing device 102 to enable the image acquisition unit 106 to capture the images/videos of a face of the user/driver. The processing device 102 can be configured with a pre-trained eye gaze detection module as shown in FIGS. 5A and 5B, which can cause the processing device 102 to crop one or more eye regions from the captured images of the face of the user/driver and correspondingly determine a yaw and a pitch indicative of the gaze direction of the user/driver for a real-time frame as well as for one or more previous time frames.

In an embodiment, the processing device 102 can be further configured with a learning module 214 such as an LSTM model as shown in FIG. 5B, which can cause the processing device 102 to estimate a subsequent eye gaze direction of the user/driver based on the gaze directions being determined for the real-time frame and one or more previous time frames.

In an embodiment, the processor can cause the processing device 102 to project the estimated subsequent gaze direction in a 3D coordinate system of the vehicle, and match the estimated subsequent gaze direction with regions of interest (ROI) of the display 104-1 in the interior of the vehicle. Further, the learning module 214 can cause the processing device 102 to derive a confidence region indicative of an ellipse in the interior of the vehicle, where the yaw and pitch of the estimated subsequent gaze direction can correspond to the center points of the ellipse, and variance of the yaw and pitch of the corresponding gaze directions being determined for the real-time frame, and the one or more previous time frames can correspond to radii of the ellipse as shown in FIG. 6. Furthermore, the learning module 214 can cause the processing device 102 to calculate the overlap between the ellipse and the ROI (display 104-1 of the infotainment system 104) as shown in FIG. 7 and correspondingly adjust the brightness of the display 104-1. In an implementation, the processing device 102 can be configured to keep the brightness level of the display 104-1 at the predefined level for a predefined time after the estimated subsequent gaze direction exits the ROI.

$$\frac{{( x - h )}^{2}}{{yawV}^{2}} + \frac{{( y - k )}^{2}}{p i {tchV}^{2}} = 1 ,$$

A cartesian equation where h and k are projection of early predicted yaw and pitch on 3D plane, is used to detect and calculate the overlap detection between the ellipse with pitch and yaw of the predicted subsequent gaze direction as center points and variance of pitch and yaw of the current and previous estimated gaze directions as radii.

Yaw variance and pitch variance are calculated using the below equations for the past N frames (i∈{t, t−1, . . . , t−n−1}).

$$yawV = \sqrt{\sum \frac{{( {h}_{i} - yawMean )}^{2}}{N - 1}}$$

$$pitchV = \sqrt{\sum \frac{{( {k}_{i} - pitchMean )}^{2}}{N - 1}}$$

The cartesian equation for a 2p×2q rectangle as ROI is

$${( \frac{x}{p} )}^{2} + {( \frac{y}{q} )}^{2} = {sec ( arctan ( \frac{x}{p} , \frac{y}{q} ) - \frac{π}{2} ⌊ \frac{2}{π} arctan ( \frac{x}{p} , \frac{y}{q} ) + \frac{1}{2} ⌋ )}^{2} \qquad ( Equation 1 )$$

The equation of ellipse with center h, k is

$$\frac{{( x - h )}^{2}}{{α}^{2}} + \frac{{( y - k )}^{2}}{{b}^{2}} = 1 \qquad ( Equation 2 )$$

Substituting value of x or y from Equation 1 in Equation 2 gives us the intersection point.

In one or more examples, if the 3D projection of the predicted yaw and pitch (ellipse) is calculated to lie inside the ROI, then the ROI of the infotainment system can be triggered. Further, if no solution is determined, then no intersection is present between the ROI and ellipse, which means the ROI is not triggered. Furthermore, if only one solution is present, the ellipse is only touching the edge of the ROI. Furthermore, if more than one solution is present, then the ROI can be triggered.

In an embodiment, the actuation and control unit 216 can cause the processing device 102 to transmit a set of control signals to the infotainment system 104 or VCU 108 to adjust the brightness of the display 104-1 of the infotainment system 104 at a predefined level based on an overlap between the ROI of display and the estimated subsequent gaze direction of the user/driver. Accordingly, the system 100 accurately identifies the direction in which the driver is currently looking at and will be looking at in subsequent time frames while driving the vehicle, which helps control the brightness of the infotainment screen of the vehicle. The processing device 102 can trigger the ROI of the display 104-1 of the infotainment system 104 when the derived confidence region lies inside the ROI associated with the display 104-1 of the infotainment system 104.

In another embodiment, the ROI can be a road where the vehicle is running. The alert unit 218 can cause the processing device 102 to generate an alert when the estimated gaze direction of the user/driver is estimated to be off the road (ROI) for a first predefined time indicating the user/driver is distracted. Further, the alert unit 218 can also cause the processing device 102 to generate an alert when the eye of the user/driver is found to be closed for a second predefined time indicating the user/driver to be sleeping or unconscious.

Referring to FIGS. 5A and 5B, where an exemplary architecture of the gaze detection module 212 of the proposed system 100 using an LSTM model is illustrated, in an embodiment, the pre-trained eye gaze detection module 212 can include a first branch comprising a first neural network architecture to regress the corresponding images of the eye to gaze maps. Further, the pre-trained eye gaze detection module 212 can include a second neural network architecture to regress the gaze maps to the gaze direction represented by the yaw and pitch. The pre-trained eye gaze detection module 212 can include a second branch fed by the gaze maps and configured as a classification network architecture to reduce entropy loss for enabling the model to determine real gaze maps based on training with synthetic data. The LSTM model can include one or more LSTM layers, dropout layers, and dense layers.

In an exemplary embodiment, the eye gaze detection module 212 can be pre-trained with synthetic and/or real-time data by reducing M-Entropy losses. The pre-trained eye gaze detection module 212 can enable the processing device 102 to detect eye occlusion on at least one of the eye regions from the captured images. The processing device 102 can correspondingly select and detect the corresponding gaze direction from a non-occluded eye image. This allows the system 100 to identify the direction in which the user/driver wearing eyeglasses or sunglasses is looking and will be looking while driving the vehicle to help control the brightness of the infotainment screen of the vehicle.

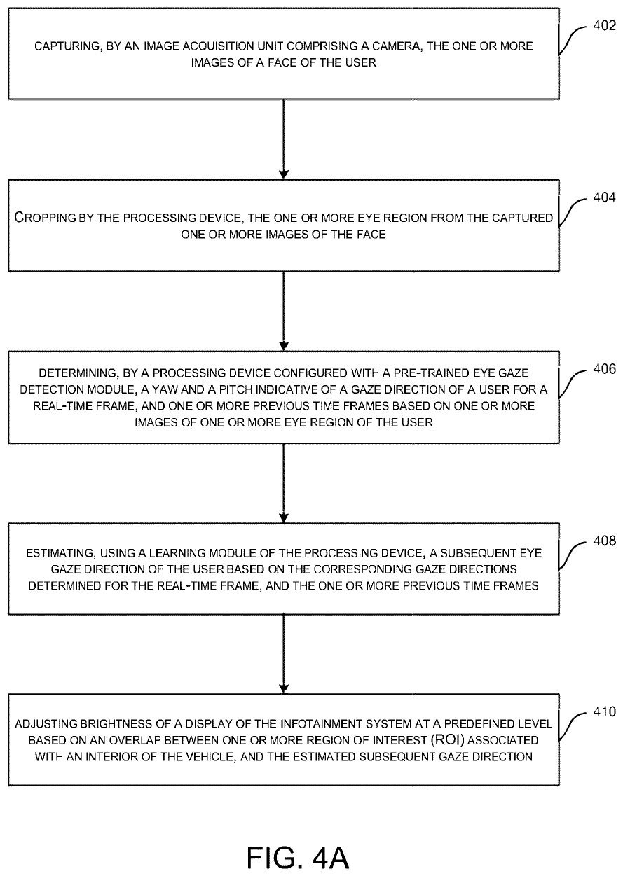

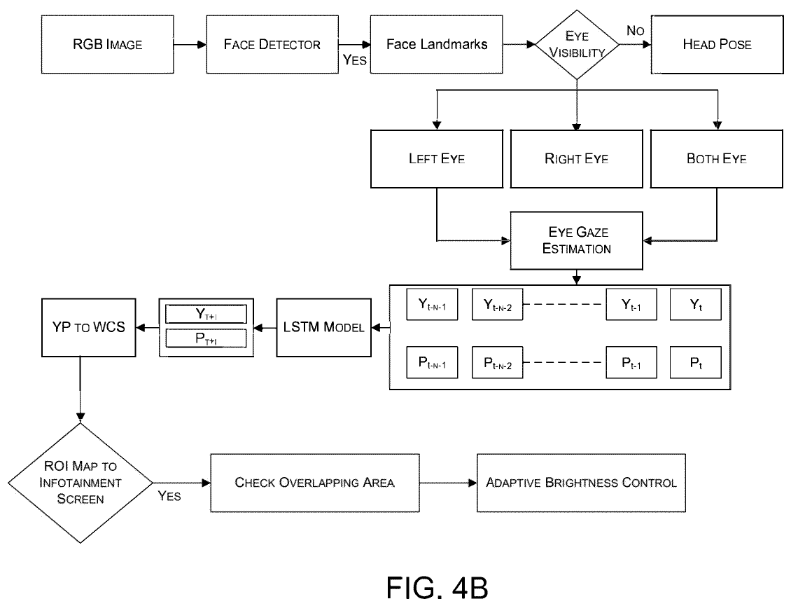

Referring to FIGS. 4A and 4B, the proposed method 400 for controlling the brightness of an infotainment system of a vehicle, involves the image acquisition unit, and the processing device connected with the infotainment system. The method 400 includes step 402 of capturing, by an image acquisition unit comprising a camera, the image(s) of the face of the user/driver. The method 400 further includes step 404 of cropping, by a processing device, the one or more eye regions from the images of the face captured at step 402. Step 404 may involve a face detector that detects the face from the captured images based on face landmarks present in the images. Further, the eye regions are cropped from the images of the face, otherwise, the head pose may be detected for eye gaze detection. The region of the left eye, right eye, or both eyes can be cropped from the face image.

The method 400 further includes step 406 of determining, by a pre-trained eye gaze detection module associated with the processing device, a yaw and a pitch indicative of a gaze direction of a user/driver for a real-time frame, and one or more previous time frames based on the images of the one or more eye region of the user/driver being cropped at step 404. The method 400 further includes step 408 of estimating, using a learning module (LSTM model) associated with the processing device, a subsequent eye gaze direction of the user based on the corresponding gaze directions being determined for the real-time frame, and the one or more previous time frames at step 406.

Further, the method 400 includes step 410 of adjusting the brightness of a display of the infotainment system at a predefined level based on an overlap between one or more regions of interest (ROI) associated with an interior of the vehicle, and the estimated subsequent gaze direction being estimated at step 408. The ROI can be associated with the display of the infotainment system. At step 410, if the ROI is mapped to the display of the infotainment system, the overlapping area between the ROI and the estimated subsequent gaze direction can be used to adjust the display brightness.

In an embodiment, at block 410, the method 400 includes the step of deriving, by the processing device, a confidence region indicative of an ellipse in the interior of the vehicle as shown in FIG. 6. As illustrated, the yaw and pitch of the estimated subsequent gaze direction can correspond to the center points of the ellipse. Further, the variance of the yaw and pitch of the corresponding gaze directions being determined for the real-time frame, and the one or more previous time frames can correspond to the radii of the ellipse. The method 400 further includes the step of calculating, by the processing device, the overlap between the ellipse and the ROI of the display as shown in FIG. 7, followed by the step of correspondingly controlling the brightness of the display. Furthermore, the ROI of the infotainment system can be triggered when the derived confidence region lies inside the ROI.

In an embodiment, when one of the eyes of the user/driver is occluded in the captured images of the face, the method 400 can include the step of detecting eye occlusion on at least one of the eye regions from the captured one or more images, followed by a step of detecting the corresponding gaze direction from a non-occluded eye image. In another embodiment, the method 400 can include the steps of keeping the brightness level of the display at the predefined level for a predefined time after the estimated subsequent gaze direction exits the ROI.

Thus, the present invention (system and method) accurately identifies the direction in which the user/driver is looking and will be looking while driving the vehicle, and accordingly help control the brightness of the infotainment screen of the vehicle. This helps reduce eye strain and distraction to accurately identify the direction in which the user/driver is looking and will be looking while driving the vehicle, help control the brightness of the infotainment screen of the vehicle during night time, provide hands-free brightness control of the infotainment system, save energy, and provide a comfortable driving experience.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

The present disclosure controls the brightness of an infotainment system in a vehicle based on the eye-gaze direction of the driver.

The present disclosure provides a system and a method for controlling the brightness of an infotainment system in a vehicle using eye-gaze estimation.

The present disclosure accurately identifies the direction in which the driver is looking and will be looking while driving a vehicle to help control the brightness of the infotainment screen of the vehicle.

The present disclosure provides a system and a method for controlling the brightness of an infotainment system, which helps reduce eye strain and distraction to drivers during nighttime.

The present disclosure provides a system and a method that provides hands-free brightness control of an infotainment system in vehicles.

The present disclosure efficiently controls the brightness of the infotainment system screen in vehicles to save energy and provides a comfortable driving experience.

1-9. (canceled)

10. An infotainment brightness control system for an infotainment system of a vehicle, the infotainment brightness control system comprising:
a processing device configured with a pre-trained eye gaze detection module and a learning module, wherein the pre-trained eye gaze detection module comprises
a first branch comprising
a first neural network configured to regress corresponding images of an eye to gaze maps, and
a second neural network configured to regress the gaze maps to a gaze direction represented by a yaw and pitch; and
a second branch fed by the gaze maps and configured as a classification network configured to reduce entropy loss to enable a model to determine real gaze maps based on training with synthetic data,
wherein the eye gaze detection module is pre-trained with synthetic or real time data including cropped images of eye regions; and
a memory, wherein the processing device comprises a processor coupled with the memory, wherein the memory stores one or more instructions executable by the processor to
determine, using the pre-trained eye gaze detection module, based on one or more images of one or more eye region of a user, a yaw and a pitch indicative of a gaze direction of the user for a real-time frame and one or more previous time frames;
estimate, using the learning module, a subsequent eye gaze direction of the user based on the gaze directions determined for the real-time frame and the one or more previous time frames; and
transmit a set of control signals to the infotainment system to adjust brightness of a display of the infotainment system at a predefined level based on an overlap between one or more regions of interest associated with an interior of the vehicle, and the estimated subsequent gaze direction.

11. The system of claim 10, further comprising:
an image acquisition unit comprising a camera configured to capture the one or more images of a face of the user, wherein the eye gaze detection module configures the processing device to
crop the one or more eye region from the captured one or more images of the face; and
determine, based on the cropped images of the eye region, the yaw and the pitch indicative of the corresponding gaze direction of the user.

12. The system of claim 10, wherein the processing device is configured to project the estimated subsequent gaze direction in a 3D car coordinate system, and match the estimated subsequent gaze direction with the one or more regions of interest in the interior of the vehicle.

13. The system of claim 10, wherein the one or more regions of interest is/are associated with the display of the vehicle or the infotainment system.

14. The system of claim 10, wherein the processing device is configured to:
derive a confidence region indicative of an ellipse in the interior of the vehicle, wherein the yaw and pitch of the estimated subsequent gaze direction corresponds to center points of the ellipse, and variance of the yaw and pitch of the corresponding gaze directions is determined for the real-time frame, and the one or more previous time frames corresponds to radii of the ellipse; and
calculate the overlap between the ellipse and the one or more regions of interest, and correspondingly adjust the brightness of the display,
wherein the processing device triggers the one or more regions of interest of the infotainment system when the derived confidence region lies inside the one or more regions of interest.

15. The system of claim 10, wherein the processing device is configured to detect eye occlusion on at least one of the eye regions from the captured one or more images, and is configured correspondingly select and detect a corresponding gaze direction from a non-occluded eye image.

16. The system of claim 10, wherein the processing device is configured to maintain the brightness level of the display at the predefined level for a predefined time after the estimated subsequent gaze direction exits the region of interest.

17. A method for controlling brightness of an infotainment system of a vehicle, the method comprising:
determining, by a processing device configured with a pre-trained eye gaze detection module, a yaw and a pitch indicative of a gaze direction of a user for a real-time frame and one or more previous time frames based on one or more images of one or more eye region of the user;
estimating, using a learning module of the processing device, a subsequent eye gaze direction of the user based on corresponding gaze directions determined for the real-time frame and the one or more previous time frames; and
adjusting the brightness of a display of the infotainment system at a predefined level based on an overlap between one or more region of interest associated with an interior of the vehicle, and the estimated subsequent eye gaze direction.

18. The method of claim 17, further comprising:
capturing, by an image acquisition unit comprising a camera, the one or more images of a face of the user,
cropping, by the processing device, the one or more eye region from the captured one or more images of the face; and
determining, by the processing device, based on the cropped images of the eye region, the yaw and pitch indicative of the gaze direction of the user.
